(19) United States
(12) Patent Application Publication
(10) Pub. No.: US 2010/0066850 A1
(43) Pub. Date: Mar. 18, 2010

(54) MOTION ARTIFACT MEASUREMENT FOR DISPLAY DEVICES

(75) Inventors: Michael D. Wilson, St. Charles, MO (US); Yue Cheng, Lake St. Louis, MO (US)

Correspondence Address: SENNIGER POWERS LLP, 100 NORTH BROADWAY, 17TH FLOOR, ST LOUIS, MO, 63102, US

(73) Assignee: WESTAR DISPLAY TECHNOLOGIES, INC., St. Charles, MO (US)

(21) Appl. No.: 12/516,850

(22) PCT Filed: Nov. 30, 2007
(86) PCT No.: PCT/US2007/086012

§ 371 Date: May 29, 2009

Related U.S. Application Data
(60) Provisional application No. 60/867,989, filed on Nov. 30, 2006.

(51) Int. Cl. H04N 5/228

(52) U.S. Cl. 348/222.1

(57) ABSTRACT

A video signal generator provides a test pattern to a display device for measuring a motion artifact (e.g., moving-edge blur) of the display device. The test pattern includes a moving image and a shift velocity of a time-delay integration (TDI) camera is matched to the velocity of the moving image to track a moving edge of the image. The captured image is analyzed to determine a characteristic indicative of the motion artifact of the display device (e.g., the blur edge time).

### BACKGROUND

Display technologies for use in plasma display panels, active matrix liquid crystal displays, organic light emitting diode displays, surface emitting diode displays, digital light projection displays, and the like have inherent strengths and weaknesses. To improve the suitability of these displays for television and other display applications, manufacturers desire the ability to accurately measure motion picture quality aspects of each display. One such measurement indicative of the quality of a display in a television application is Motion-Picture Response Time (MPRT), now known as Moving-Edge Blur according to VESA Standard 309-1 (Video Electronic Standards Association, “Flat Panel Display Measurement Standard Version 2.0 Update”, May 19, 2005; Standard 309-1). Other motion artifact measurements indicative of the quality of a display in a television application include line-spreading, contrast degradation, dynamic false contour generation, and motion resolution. Moving-edge blur measurements simulate a human visual action known as smooth pursuit eye tracking, or simply smooth pursuit, to quantify the ability of a display to accurately render moving images.

Visual display devices display moving images as a succession of short duration stationary images called frames. If these images are presented in rapid succession (e.g., a frame rate exceeding about 24 frames per second), the human vision system integrates the images and interprets them as a continuously moving video image. Smooth pursuit occurs when a human tracks a moving object presented by a display. Unfortunately, many displays introduce artifacts when displaying motion video images. Existing methods measure the moving-edge blur of a display to quantify artifacts in the moving images. Such methods include the pursuit camera measurement method, the time-based-image integration measurement (TIM) method, and the stationary display response time calculation method.

The pursuit camera measurement method involves a camera, a motion device, and the display under test. A test pattern (usually a vertically oriented, horizontally moving line) is provided to the display under test, and the camera tracks a fixed point of the test pattern such that the test pattern appears fixed in images taken by the camera. The images are analyzed to determine the moving-edge blur of the display. The motion device may take several forms. For example, the motion device may be adapted to move the display relative to the camera, move the camera relative to the display, or rotate the camera to simulate relative movement. In another form, the motion device includes an optical component (mirror). The camera is fixedly pointed at the optical component, and the display under test is stationary. The motion device rotates the optical component such that the camera perceives motion relative to the display. Although the pursuit camera measurement method directly emulates smooth pursuit, the motion device and test pattern must be precisely controlled to obtain an accurate measurement of the moving-edge blur of the display under test. Also, any vibrations or misalignments of the camera or mirror (if used) are significant sources of error in the measurement.

The time-based image integration method (TIM) utilizes a stationary high-speed camera to measure the moving-edge blur of the display under test. The test pattern (e.g., the vertically oriented, horizontally moving line previously described) is displayed on the device under test, and the camera captures images of the display in rapid succession (e.g., about 10 to 20 times the frame rate of the display under test or 600 frames per second). A processor then shifts the images such that the test pattern is aligned in each image, and adds the images together. The TIM method eliminates the use of a complicated motion device and therefore eliminates many sources of error while emulating smooth pursuit. But the images have reduced sensitivity and a relatively low signal to noise ratio because the TIM method uses a camera with frame rates of around 600 Hz and a correspondingly short exposure time. Combining multiple images can improve signal to noise ratio but this requires precise triggering between the test pattern and camera, and many displays include signal processing (e.g., scalers and frame buffers) that interfere with this triggering.

The stationary display response time calculation method utilizes a stationary photo detector to measure the response time of a display under test. The display under test is provided with a test pattern that switches an area of the display observed by the photo detector from a first gray scale level to a second (i.e., first luminance to a second luminance), and a processor measures the response time of the display via the photo detector. The moving-edge blur of the display is then calculated by convolving the response time with a sampling function such as a moving window average filter. The stationary display response time calculation method is useful because of its sensitivity to low light levels. It is also useful in tuning signal over-drive levels. Unfortunately, calculating the stationary display response time in this manner does not provide a direct measurement of moving-edge blur and cannot be applied to displays that employ motion compensated edge enhancement filtering or complex moving images. Moreover, it requires a detailed knowledge of the display drive scheme (for measurement timing purposes).

### SUMMARY

Aspects of the present invention overcome deficiencies in the prior art and provide improved motion artifact measurements. For example, a system for measuring moving-edge blur of a display device uses a time-delay and integration method including a camera having a charge coupled device (CCD) sensor, a video signal generator, and an image processor. The video signal generator provides a test pattern to a display under test, and the camera captures an image of a moving visual component (e.g., a transition line) within the test pattern displayed by the display device. The camera shifts the image across its CCD to integrate accumulated charge at each pixel of the CCD and track the motion of the moving visual component within the test pattern that results in an image of the moving visual component as displayed by the display. The image processor analyzes the image to determine the moving-edge blur of the tested display. Thus, the system directly emulates smooth pursuit, has no moving parts, and has a long effective exposure time due to the integration of the image as it is shifted across the CCD sensor. This results in reduced noise and increased accuracy.

Further aspects of the invention align the camera relative to the display. The video signal generator provides an alignment test pattern to the display device. For example, the alignment pattern includes a fixed object, such as a line having a predetermined number of display pixels in width. The camera provides an image of the fixed object as displayed by the display device to the image processor. The image processor analyzes the image to determine a spatial characteristic of the camera relative to the display. In one instance, the spatial characteristic is rotational alignment of the camera to the display. The system adjusts the relative rotational alignment of the camera to the display such that the pixels of the camera are aligned with the pixels of the display device. In another instance, the spatial characteristic is a magnification or zoom of the camera to the display measured as a ratio of display device pixels to camera pixels. The magnification or zoom is adjusted such that the ratio is equal to a predetermined ratio (e.g., a function of a frame rate of the display device and a velocity of the moving visual component of the test pattern).

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is a block diagram of a system for measuring moving-edge blur via the time-delay integration (TDI) method according to one embodiment of the invention.

FIG. 2A is an exemplary alignment pattern provided to a display under test according to one embodiment of the invention.

FIG. 2B is an exemplary test pattern provided to a display under test according to one embodiment of the invention.

FIG. 3 is a schematic diagram of a time-delay integration interline charge coupled device (CCD) according to one embodiment of the invention.

FIG. 4 is an image of the test pattern of FIG. 2A as displayed by a display under test and captured by an embodiment of the invention.

FIG. 5 is a graph of luminance over time of the captured image of FIG. 4 according to one embodiment of the invention.

FIG. 6 is a graph of blur edge times for various changes in luminance as displayed by a display under test and measured by the TDI moving-edge blur measurement system according to one embodiment of the invention.

FIG. 7 is an example of a second test pattern provided to a display under test according to one embodiment of the invention.

Corresponding reference characters indicate corresponding parts throughout the drawings.

### DESCRIPTION

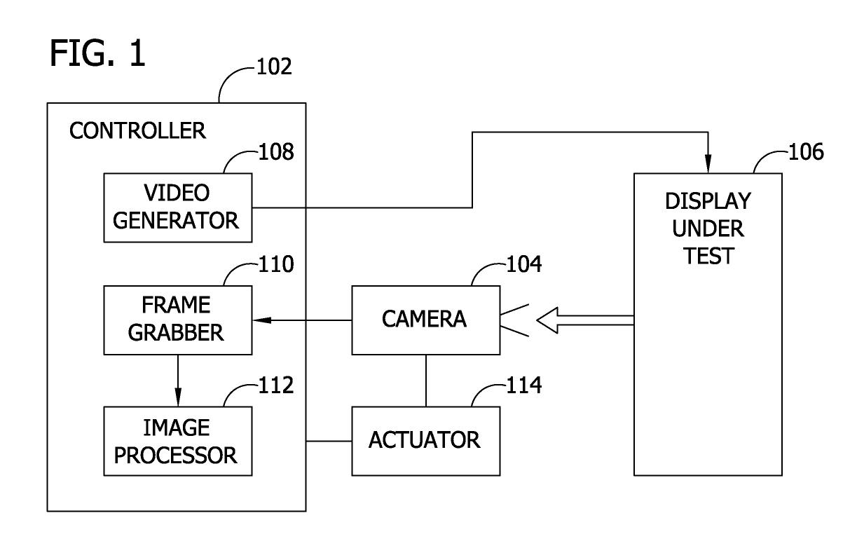

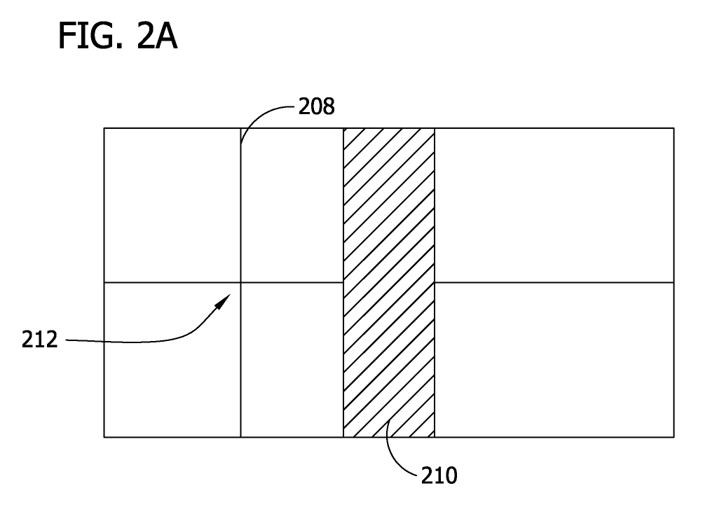

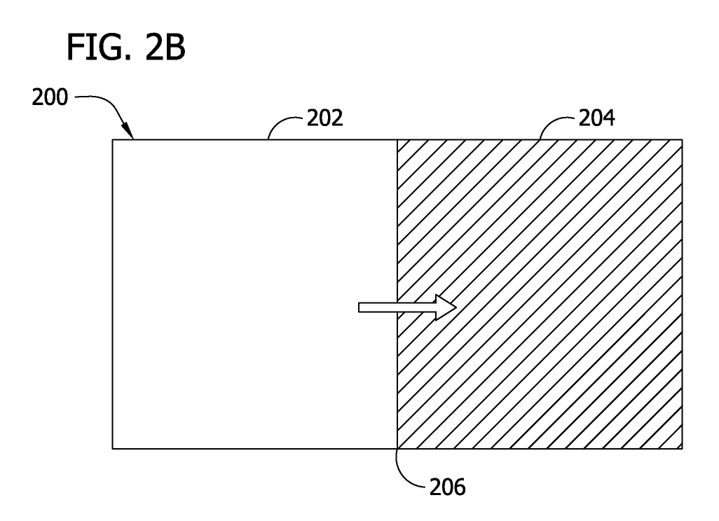

Referring to FIG. 1, a controller 102 operates a camera 104 and a display under test (DUT) 106 to measure a moving-edge blur characteristic of the DUT 106. In one embodiment, the camera 104 includes a charge coupled device (CCD) sensor array (not shown) for receiving light transmitted to it via a lens (not shown). The controller 102 includes a video signal generator 108 and a frame grabber 110. According to an embodiment of the invention, the video signal generator 108 sends a test pattern with a moving visual component (see FIG. 2B) to DUT 106 for display. The camera 104, which has a fixed position relative to DUT 106, observes the test pattern on DUT 106 and provides its output signal to the frame grabber 110 of controller 102. The frame grabber 110 compiles a blur edge profile from the signal provided by camera 104, and an image processor 112 determines a parameter of the blur edge profile indicative of the moving-edge blur exhibited by DUT 106. In one embodiment, the determined parameter is blur edge width or blur edge time or a combination of both as further explained below.

Proper physical setup of the camera 104 with respect to the DUT 106 improves the accuracy of the moving-edge blur measurement. Proper setup includes focusing the camera 104 on the DUT 106; rotationally aligning the camera 104 with respect to the DUT 106; adjusting the combination of lens magnification, velocity of a moving visual component (e.g., a moving edge or a transition line) in the test pattern such that the velocity of the moving edge as projected by the lens of camera 104 onto the CCD sensor of camera 104 matches the shift rate of the CCD; and ensuring that an effective exposure time of a captured image is a multiple of the frame time (i.e., inverse of the frame rate) of DUT 106.

Referring to FIG. 2A, one method of establishing proper rotational alignment of the camera 104 to the DUT 106 is to display an alignment test pattern (e.g., one or more of the following: a line 208, a bar 210, a grill (not shown), or a cross-hair pattern 212) on DUT 106 and capture an image of the resulting display with camera 104. The camera 104 or the DUT 106 can then be rotated to bring the field-of-view of camera 104 into alignment with DUT 106. Any adjustments may be made manually or automated by determining necessary adjustments via image processing techniques and rotating the camera 104 and/or DUT 106 via an actuator 114.

According to an aspect of the invention, camera or lens magnification is determined by displaying an alignment test pattern (e.g., the pattern of FIG. 2A) comprising, for example, a vertical bar 210 on DUT 106. In this embodiment, the bar 210 of the alignment pattern has a known width in DUT pixels. The camera 104 acquires an image of the bar 210 and image processor 112 processes the image to determine the width of the bar 210 in camera CCD pixels. The ratio of DUT pixels to camera CCD pixels yields the magnification. The magnification may be set such that during moving edge blur measurement, a moving edge of the test pattern travels across the CCD of camera 104 in an integer multiple of DUT video frame periods. If a zoom lens is used on camera 104, the magnification can be adjusted by changing the zoom setting. On the other hand, if a fixed focus lens is used, the distance between camera 104 and DUT 106 can be changed to adjust the magnification. In this manner, image processor 112 determines a characteristic of a spatial relationship (e.g., magnification or angle of rotation) between camera 104 and DUT 106. The spatial relationship is a magnification of the camera in one embodiment of the invention. In this instance, the shift frequency of the camera 104 is determined as a function of one or more of the following: a ratio of display device pixels to camera pixels, a frame rate of the display device, and a velocity of the moving visual component of the test pattern. For example, shift frequency is the product of the ratio of display device pixels to CCD pixels, frame rate of the display, and velocity (pixels per frame) of a moving visual component of a test pattern. The quantity of shifts per image is equal to the shift frequency of the camera 104 divided by an integer multiple of the frame rate of the display device 106.

In one embodiment, the camera 104 is a time-delay integration (TDI) linescan camera. To capture stationary images for adjusting the rotational alignment, focus, and magnification of camera 104, the TDI line scan camera is driven in a non-standard fashion that allows camera 104 to emulate a full-frame area scan CCD camera. The camera 104 acquires an image without continuously reading lines out of the camera (i.e., not continuously shifting charges across the TDI stages of the camera). After a predetermined exposure time has elapsed, the entire image is read out from camera 104 to image processor 112 at a relatively fast rate (e.g., as fast as possible). In the case of a 64 stage by 2048 pixel camera, this produces a 64 pixel by 2048 pixel image that is clear enough to enable the alignment methods disclosed herein.

Referring to FIG. 2B, video signal generator 108 provides a test pattern 200 for use with the present invention. The DUT 106 displays the test pattern 200 as two regions 202, 204 separated by a transition line 206. In one embodiment, a first region 202 of the test pattern 200 has a relatively high luminance (i.e., appears light or is relatively high on the gray scale), and a second region 204 has a relatively low luminance (i.e., appears dark or is relatively low on the gray scale). Alternatively, the first region 202 of test pattern 200 has a relatively low luminance and the second region 204 has a relatively high luminance compared to each other. In another embodiment, the first region 202 comprises a foreground color and the second region 204 comprises a background color different than the foreground color. The transition between the two regions 202, 204 forms the vertical transition line 206. Also, the test pattern 200 has a moving visual component oriented in a first direction and traveling in a second direction. For example, the transition line 206 is oriented generally vertically and moves horizontally across the DUT 106 as indicated by the arrow to provide a transition edge for measuring the moving-edge blur of the DUT 106. In at least one embodiment of the invention, the test pattern 200 is a complex image having a moving visual component. For example, the complex image may be a bit map image that is moved across the DUT 106 by the video signal generator 108. For instance, camera 104 (e.g., a TDI camera) captures the bit map and processor 112 analyzes the captured image for degradation and/or artifacts as compared to the original static image, i.e., the test pattern.

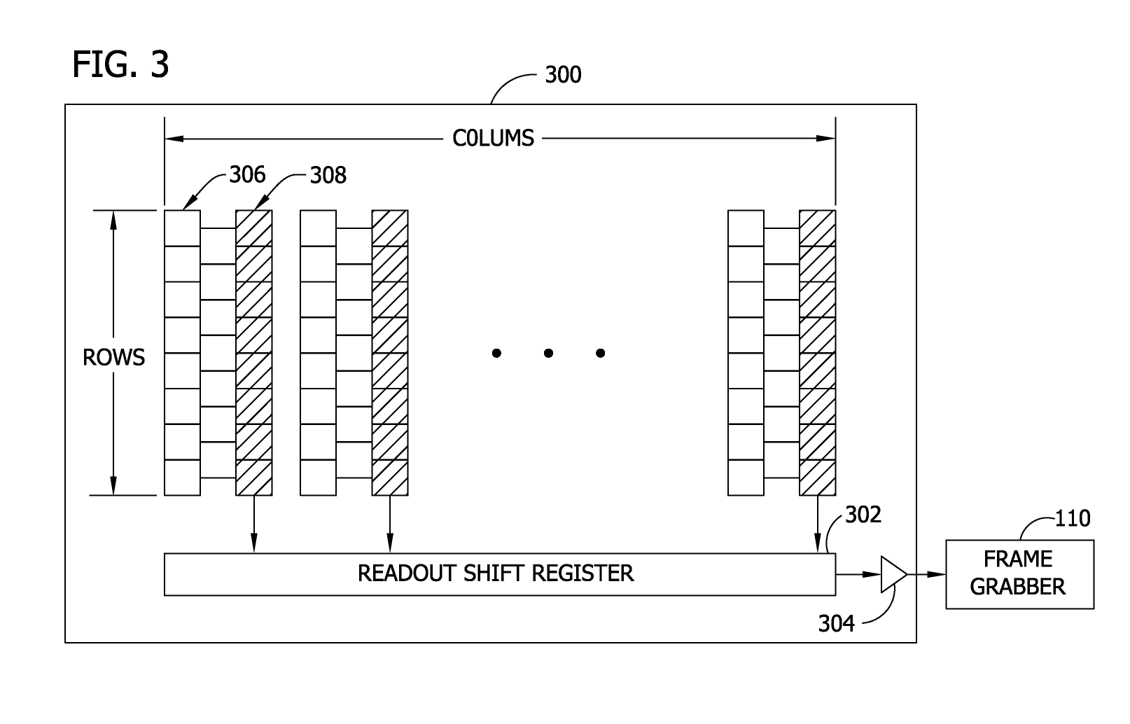

FIG. 3 illustrates a charge coupled device (CCD) 300 of camera 104 according to an embodiment of the invention. In operation, the CCD 300 captures an image of test pattern 200 for output to frame grabber 110 via a readout shift register 302 and a buffer 304. The CCD 300 comprises a matrix of pixels having a number of columns and a number of rows. The CCD 300 shown in FIG. 3 is, for example, an interline CCD such that each column of CCD 300 comprises a column of unmasked pixels 306 and a column of masked pixels 308. The camera 104 is focused on DUT 106 such that CCD 300 is exposed to the test pattern 200 (as displayed by DUT 106) when a shutter (not shown) of camera 104 is opened. In one embodiment of the invention, the camera 104 is electronically shuttered. That is, accumulated charge in the unmasked pixels 306 and the masked pixels 308 is cleared just prior to beginning an image acquisition. In the electronically shuttered embodiment, at the completion of the exposure no additional charge is transferred from the unmasked pixels 306 to the masked pixels 308.

When DUT 106 displays test pattern 200, the shutter opens (or the camera 104 is electronically shuttered), and CCD 300 develops a charge in unmasked pixels 306. The CCD 300 shifts the charge in each unmasked pixel 306 to a corresponding masked pixel 308. The charges in the masked pixels 308 are then shifted toward the readout shift register 302, in the same direction of movement as the image of transition line 206 of test pattern 200, and the charges are shifted into readout shift register 302. Some charges in the readout shift register 302 are disregarded such that an image captured by CCD 300 does not contain partially exposed pixels. The unmasked pixels 106 continue to accumulate new charge during the time that the charges in the masked pixels 308 were being shifted. These new charge accumulations are shifted into the masked pixels 308 corresponding to the unmasked pixels 306 containing each new charge such that the charges, or developing image, have effectively shifted by one pixel in the column of masked pixels 308. Until all of the masked pixels 308 in CCD 300 contain charges that have been fully exposed, unmasked pixels 306 accumulate additional charge and the shifting operations of CCD 300 repeat an integer multiple of the frame time of the DUT 106. The shifting operations include shifting the charges accumulated in the unmasked pixels 306 into the corresponding masked pixels 308 and shifting the charges in the masked pixels 308 toward readout shift register 302. Once the masked pixels 308 contain charges that have been fully exposed, no additional charge is shifted into the masked pixels 308 from the unmasked pixels 306. The readout shift register 302 shifts the accumulated charge from each column and provides representative data to frame grabber 110 via the buffer 304. The frame grabber 110 compiles the data into an image or blur edge image. In an embodiment employing an interline camera, the interline camera uses a method known as partial frame TDI, in which the image is shifted a specified number of pixels across the CCD and not across the entirety of the CCD before the image is read out. In effect, the partial frame TDI method allows a variable number of TDI stages.

The camera 104 is operated by controller 102 such that the charges are shifted in sync with the movement of transition line 206 across DUT 106. The DUT 106 has a native frame rate, and test pattern 200 is correlated to this native frame rate of DUT 106 such that transition line 206 moves a predetermined number of pixels across DUT 106 per frame. The region traversed by the transition line 206 between each frame is referred to as a jump region. The shift frequency of CCD 300 is equal to the product of the number of pixels in the shift direction, the camera magnification (CCD pixels per DUT pixel) and the frame rate of DUT 106. The pixel width of the jump region is arbitrarily selected, but is generally about 4 to 32 DUT pixels. For example, in one instance, the width of the jump region is selected to be 16 DUT pixels, the DUT frame rate is 60 Hz, the number of jump regions is selected to be 1, the camera magnification (CCD pixels per DUT pixel) is 4.0, and the shift frequency is thus 3840 Hz.

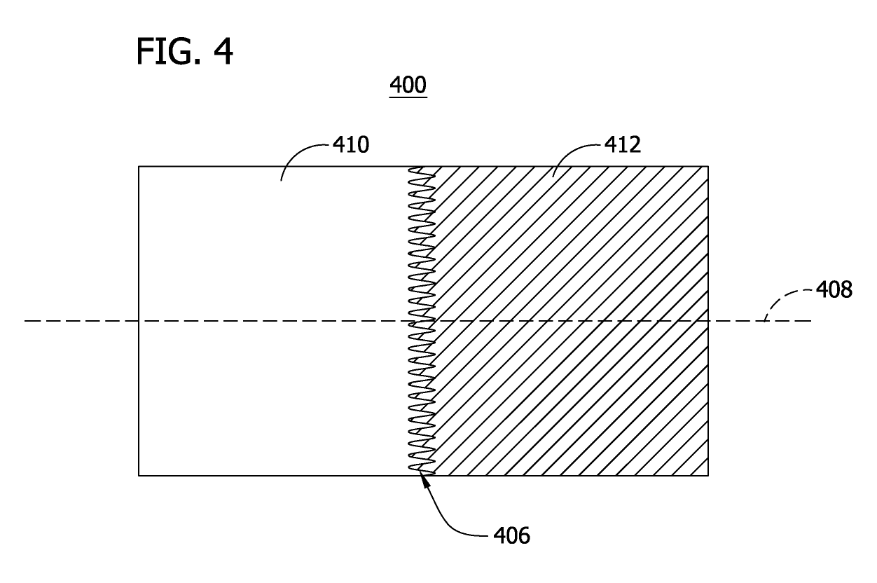

FIG. 4 is an example of a blur edge image 400 compiled by frame grabber 110 according to an embodiment of the present invention. The blur edge image 400 is similar in appearance to test pattern 200, but the transition line 406 is not as precise (i.e., the transition line 406 is generally slightly blurred) as the transition line 206 of test pattern 200. Because the DUT 106 has uniform display characteristics, a selected row 408 of the blur edge image 400 is representative of each of the rows. As with the test pattern 200, the blur edge image 400 has two regions 410, 412 separated by transition line 406. In one embodiment, a first region 410 of blur edge image 400 has a relatively high luminance (i.e., appears light or is high on the gray scale), and a second region 412 has a relatively low luminance (i.e., gives off less light, appears dark, or is relatively low on the gray scale). The transition between to the two regions 410, 412 forms the vertical transition line 406.

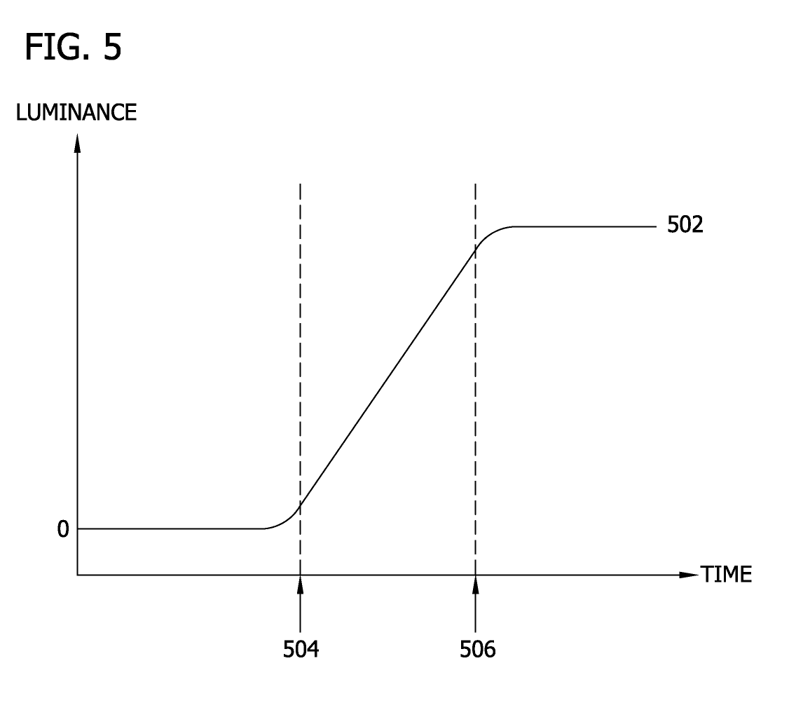

Plotting the luminance captured by the frame grabber 110 along the selected row 408 (i.e., luminance of a fixed point on the DUT 106 versus pixel position) yields a curve known as a blur edge profile. The x-axis of the blur edge profile is then scaled by the edge velocity (in DUT pixels per second) to yield a curve 502 (see FIG. 5) of luminance versus time. The frame grabber 110 compiles blur edge image 400 from right to left such that the curve 502, begins with the relatively low luminance of the second region 412 of the blur edge image 400, and gradually transitions to the relatively high luminance of the first region 410 of the blur edge image 400. In this example, the transition begins at a first time 504 when the change in luminance reaches 10% of the total luminance change for the transition and ends at a second time 506 when the change in luminance reaches 90% of the total luminance change for the transition. The difference in time (in milliseconds) between the first time 504 and the second time 506 is the blur edge time of the DUT 106 for the transition between the luminance of the first region 202 and the second region 204 of the test pattern 200. In this manner, image processor 112 determines the blur edge time from the blur edge profile 400. The curve 502 for an ideal display would be a step function, and the blur edge time would be 0. In one embodiment, the image processor 112 averages the blur edge image 400 extracted from multiple rows of DUT 106 and multiple jump regions in order to increase measurement accuracy.

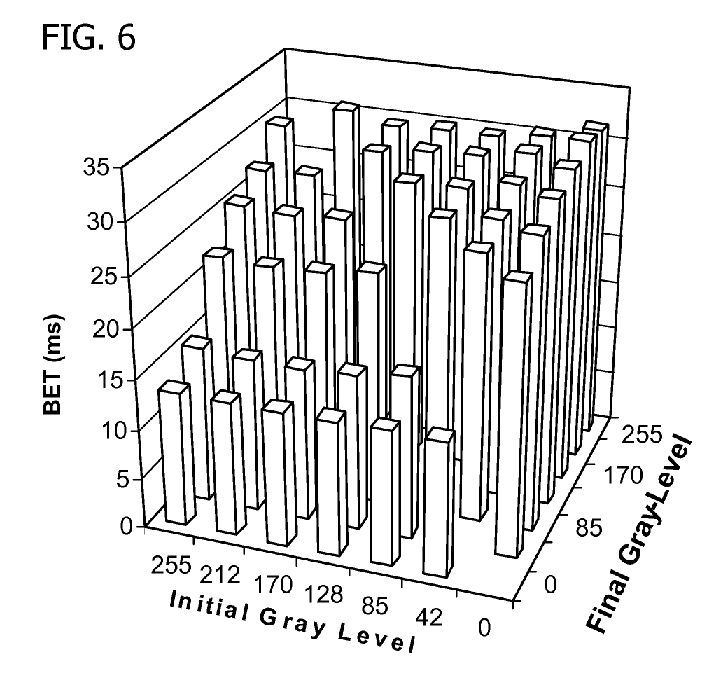

In one embodiment, the image processor 112 of controller 102 compiles blur edge profiles and determines blur edge times for a variety of luminance levels of the first region 202 and the second region 204 to generate a three-dimensional bar graph, such as shown in FIG. 6. The x-axis of the graph is the initial luminance (e.g., the luminance of the first region 202 of test pattern 200), the y-axis of the graph is the final luminance (e.g., the luminance of the second region 204 of test pattern 200), and the z-axis is the blur edge time calculated by image processor 112. The graph of FIG. 6 gives a comprehensive view of the moving-edge blur measurement of DUT 106, which may be helpful for comparing one display device (e.g., DUT 106) to another, or tuning overdrive and signal processing characteristics of the DUT 106.

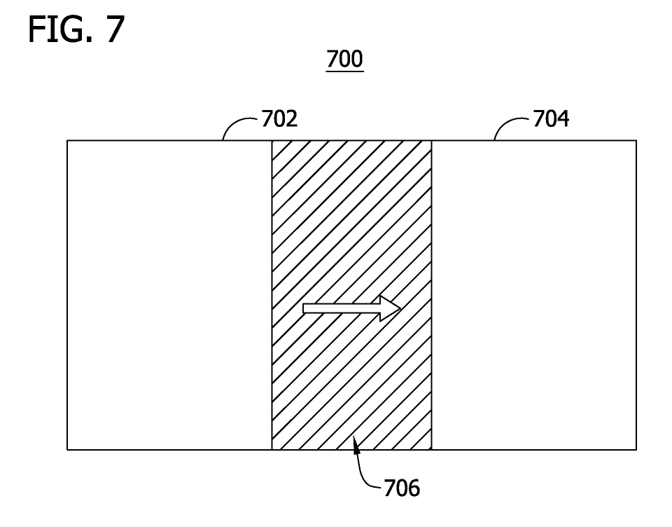

Embodiments of the invention provide a comprehensive analysis of the moving-edge blur for generating the graph of FIG. 6 by displaying a number of test patterns (i.e., test patterns such as test pattern 200 having differing initial and final luminance values), compiling a number of blur edge profiles, and determining the blur edge time for each of the numerous blur edge profiles. Referring to FIG. 7, a test pattern 700 decreases the time required to comprehensively test the moving-edge blur of DUT 106. The test pattern 700 has three luminance regions. A first region 702 has a luminance that matches the luminance of a third region 704. The first and third regions are separated by a second region 706 having a differing luminance. As illustrated, the second region 706 comprises a vertical bar of fixed width that separates the first region 702 from the third region 704 in one embodiment of the invention. This vertical bar moves in the direction indicated by the arrow. The three-region test pattern 700 yields two transition edges such that for a single blur edge image acquisition, embodiments of the invention can analyze two transitions, i.e., from a first luminance to a second luminance and from the second luminance to the first luminance.

Although the camera 104 described above with respect to FIG. 3 is an interline CCD camera, it is contemplated that cameras with other CCD types may be used without deviating from the scope of the invention. In one embodiment, for example, a TDI linescan camera is used to capture blur edge profiles. For TDI cameras it may be desirable that an integer number of jump regions fill all of the active TDI stages. Additionally, a physical shutter is generally unnecessary and there is no restriction on the width of the image. But the height of the blur edge profile may be limited to the resolution of the CCD.

A full frame CCD camera, orthogonal transfer CCD camera, or frame transfer CCD camera may also be used according to embodiments of the invention. For the full-frame CCD camera, a shutter may be used to improve the quality of the captured image. In operation, the camera opens the shutter, shifts data out of the CCD array one row at a time (note that the CCD is rotated such that the direction of the rows are perpendicular to the direction of image motion), closes the shutter after the appropriate exposure time (for example, an integer multiple of the DUT frame-time). The camera continues shifting and reading the image from the CCD array until the last exposed row is read-out. The resulting image has partially exposed regions from both the initial and final rows read from the CCD and these may be discarded (cropped) before analysis. One advantage to the full-frame, frame transfer, interline and orthogonal CCD cameras is that specific image magnifications are not necessary.

It is contemplated that at least some embodiments of the invention will be used to measure motion artifacts other than moving edge blur. In some embodiments, test patterns including complex images, such as bitmaps, varying line patterns or resolution targets may be used. In these embodiments, a moving visual component is moved across the display under test 106 at a known velocity and in a known direction via video signal generator 108. The camera 104 captures the image using frame grabber 110, and the image processor 112 determines the presence and severity of motion artifacts by comparing the captured image to the original test pattern. Motion artifacts may include line-spreading, contrast degradation, dynamic false contour generation, and motion resolution.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system for testing a motion artifact of a display device comprising:
a video signal generator for providing a test pattern to the display device, said test pattern comprising a moving visual component;
a camera having a fixed position relative to the display device, said camera capturing an image of the moving visual component of the test pattern as displayed by the display device, said camera comprising a charge coupled device (CCD) sensor, and wherein the camera shifts an accumulating charge across the CCD in synchronization with the moving visual component and compiles the image during said shifting; and
an image processor configured for processing the captured image to determine a characteristic of the display device indicative of the motion artifact of the display device.

2. The system of claim 1, wherein the moving visual component of the test pattern is oriented in a first direction and travels in a second direction substantially perpendicular to the first direction when displayed by the display device and wherein the camera shifts the charge in a direction opposite the second direction.

3. The system of claim 1, wherein the video signal generator provides the display device with an alignment test pattern having a fixed object; the camera captures an image of the fixed object as displayed by the display device; and the image processor analyzes the image of the fixed object to determine a characteristic of a spatial relationship between the camera and the display device.

4. The system of claim 3, further comprising an actuator for adjusting said spatial relationship as a function of the determined characteristic, and wherein the spatial relationship comprises a zoom characteristic of the camera and wherein the actuator adjusts the zoom characteristic such that a ratio of display device pixels to camera pixels is substantially equal to a predetermined ratio, said predetermined ratio being a function of a frame rate of the display device and a velocity of the moving visual component of the test pattern.

5. The system of claim 3, further comprising an actuator for adjusting said spatial relationship as a function of the determined characteristic, and wherein the spatial relationship comprises a distance between the camera and the display device and wherein the actuator adjusts the distance such that a ratio of display device pixels to camera pixels is substantially equal to a predetermined ratio, said predetermined ratio being a function of a frame rate of the display device and a velocity of the moving visual component of the test pattern.

6. The system of claim 3, wherein the spatial relationship comprises a magnification of the camera, and wherein a shift frequency of the camera is determined as a function of one or more of the following: a ratio of display device pixels to camera pixels, a frame rate of the display device, and a velocity of the moving visual component of the test pattern; and wherein a quantity of shifts per image is equal to the shift frequency of the camera divided by an integer multiple of a frame rate of the display device.

7. The system of claim 1, wherein the determined characteristic of the display device is at least one of the following: a moving edge response time, a motion picture response time, a blur edge profile, a blur edge time, a blur edge width, line-spreading, contrast degradation, dynamic false contour generation, and motion resolution.

8. The system of claim 1, wherein the test pattern comprises a transition line of a first region of the test pattern moving across a second region of the test pattern, and wherein the moving visual component is the transition line.

9. The system of claim 8, wherein the first region comprises a foreground color and the second region comprises a background color different than the foreground color.

10. The system of claim 1, wherein the CCD of the camera comprises at least one of the following: a time-delay integration linescan sensor, a frame-transfer CCD sensor, a full-frame CCD sensor, an interline CCD sensor, and an orthogonal transfer CCD sensor.

11. A method of determining a characteristic indicative of a motion artifact of a display device comprising:
generating a test pattern comprising a moving visual component;
providing the generated test pattern to the display device, wherein the display device displays the moving visual component of the test pattern;
capturing an image of the moving visual component of the test pattern as displayed by the display device with a charge coupled device (CCD) camera, wherein said capturing comprises shifting an accumulating charge across the CCD in synchronization with the moving visual component and compiling the image during said shifting; and
processing the captured image to determine a characteristic indicative of the motion artifact of the display device.

12. The method of claim 11, wherein generating the test pattern comprises orienting the moving visual component in a first direction and moving the moving visual component in a second direction substantially perpendicular to the first direction, and wherein the camera shifts the charge across the CCD in a direction opposite the second direction.

13. The method of claim 11, wherein processing comprises determining at least one of the following: a moving edge response time, a motion picture response time, a blur edge profile, a blur edge time, a blur edge width, line-spreading, contrast degradation, dynamic false contour generation, and motion resolution.

14. The method of claim 11, wherein the test pattern comprises a transition line of a first region of the test pattern moving across a second region of the test pattern, and wherein the moving visual component is the transition line.

15. The method of claim 11, wherein the CCD of the camera comprises at least one of the following: a time delayed integration linescan sensor, a frame-transfer CCD sensor, a full-frame CCD sensor, an interline CCD sensor, and an orthogonal transfer CCD sensor.

16. The method of claim 11, further comprising aligning the camera with the display device, said aligning comprising:
providing the display device with a second test pattern;
capturing a second image with the camera, said second image representing the second test pattern as displayed by the display device;
analyzing the captured second image to determine an angle of rotation indicative of a rotational alignment of the camera with respect to the display device; and
adjusting a spatial relationship of the camera and the display device as a function of the determined angle of rotation.

17. The method of claim 11, further comprising adjusting a magnification of the camera with respect to the display device, said adjusting comprising:
providing a second test pattern to the display device, said second test pattern having an object, said object being a predetermined number of display device pixels wide;
capturing a second image with the camera, said third image representing the object as displayed by the display device;
analyzing the second image to determine a ratio of display device pixels to camera pixels; and
adjusting a relationship of the camera relative to the display device as a function of the determined ratio.

18. The method of claim 17, wherein adjusting the relationship comprises adjusting a zoom characteristic of the camera such that the ratio of display device pixels to camera pixels is substantially equal to a predetermined ratio, said predetermined ratio being a function of a frame rate of the display device and a velocity of the moving visual component of the test pattern.

19. The method of claim 17, wherein adjusting the relationship comprises determining a shift frequency of the camera and a quantity of shifts per image, wherein the shift frequency of the camera is determined as a function of one or more of the following: a ratio of display device pixels to camera pixels, a frame rate of the display device, and a velocity of the moving visual component of the test pattern; and wherein the quantity of shifts per image is equal to the shift frequency of the camera divided by an integer multiple of a frame rate of the display device.

20. The method of claim 17, wherein adjusting the spatial relationship comprises adjusting a distance between the camera and the display device such that the ratio of display device pixels to camera pixels is substantially equal to a predetermined ratio, said predetermined ratio being a function of a frame rate of the display device and a velocity of the moving visual component of the test pattern.

21. A method of measuring a motion artifact of a display device using a time-delay integration linescan camera, said method comprising:
providing an alignment test pattern comprising a fixed object to the display device;
operating the camera in a first mode to capture a first image of the fixed object as displayed by the display device, wherein in the first mode, a sensor of the camera is exposed for a predetermined period of time before the pixels of the camera are read out of the sensor to provide the first image;
analyzing the first image to determine a characteristic of a spatial relationship between the camera and the display device and adjusting said spatial relationship as a function of said characteristic;
providing a test pattern to the display device, said test pattern comprising a moving visual component;
operating the camera in a second mode to capture an image of the moving visual component, wherein in the second mode, the sensor of the camera is exposed for a period of time, and charges developed in pixels of the sensor are shifted along the sensor at a predetermined shift frequency in the direction of the image of the moving visual component in the test pattern, and wherein the shift frequency is a function of a velocity of the moving visual component; and
processing the image of the moving visual component captured by the camera to determine a characteristic indicative of the motion artifact of the display device.

22. The method of claim 21, wherein the fixed object of the alignment test pattern is a line and the spatial relationship of the camera to the display device is an angle of rotation, and further comprising adjusting the angle of rotation such that the pixels of the camera are aligned with pixels of the display device.

23. The method of claim 21, wherein the fixed object of the alignment test pattern has a width of a predetermined number of display device pixels and the spatial relationship of the camera to the display device is a magnification, and further comprising adjusting the magnification such that a ratio of display device pixels to camera pixels is substantially equal to a predetermined ratio, said predetermined ratio being a function of a frame rate of the display device and the velocity of the moving visual component of the test pattern.

24. The method of claim 21, wherein the characteristic indicative of the moving-edge blur of the display device is at least one of the following: a moving edge response time, a motion picture response time, a blur edge profile, a blur edge time, a blur edge width line-spreading, contrast degradation, dynamic false contour generation, and motion resolution.

25. The method of claim 21, wherein in the first mode, the pixels of the camera are read out of the sensor at a maximum read rate of the camera.

26. The method of claim 21, wherein the predetermined shift frequency of the camera is a function of one or more of the following: a ratio of display device pixels to camera pixels, a frame rate of the display device, and the velocity of the moving visual component of the test pattern; and wherein a quantity of shifts per image is equal to the shift frequency of the camera divided by an integer multiple of a frame rate of the display device.
